(19) United States
(12) Patent Application Publication
(10) Pub. No.: US 2006/0028642 A1
(43) Pub. Date: Feb. 9, 2006

(54) Support device for chromophore elements

(75) Inventor: Claude Weisbuch, Paris (FR)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Genewave

(21) Appl. No.: 11/176,053

(22) Filed: Jul. 7, 2005

Related U.S. Application Data
(63) Continuation of application No. PCT/FR04/00076, filed on Jan. 15, 2004.

(30) Foreign Application Priority Data
Jan. 15, 2003 (FR) 0300412

(51) Int. Cl. G01N 21/01

(52) U.S. Cl. 356/244

(57) ABSTRACT

A support for chromophore elements, which elements are for being illuminated by excitation light to emit fluorescence at a wavelength different from that of the excitation light, the support including an internal reflective layer reflecting the light emitted by the chromophore elements, a layer of absorbent material absorbing the excitation wavelength, and a layer of material constituting an antireflection layer at said wavelength in order to avoid excitation light being reflected by the support and being added to the fluorescence emitted by the chromophore elements.

The invention relates to a support device for chromophore elements, the device being of the type commonly referred to as a “biochip”.

### BACKGROUND OF THE INVENTION

Such devices comprise a support constituted by a generally multilayer substrate having one face carrying chromophore elements which are chemical or biological molecules or dyes added or grafted to chemical or biological molecules, or semiconductor nanostructures such as quantum boxes or wires secured to such molecules, such chromophore elements emitting fluorescence at a wavelength that depends on their nature when they are excited by suitable light, with detection of such fluorescence making it possible, on the support, to identify and locate molecules that have reacted to given treatments.

Means have already been proposed, in particular in applications WO-A-02/516912, FR 01/15140, and FR 02/10285 in the name of the same inventors, for increasing the efficiencies of light excitation and emission of fluorescence, e.g. by vertical structuring for reinforcing excitation intensity and/or the intensity of the emitted fluorescence, by generating interference effects by means of mirrors. Nevertheless, in the light that is picked up by the collector and measurement means, it remains necessary to separate any excitation light reflected by the support from the emitted fluorescence, and for this purpose dichroic or absorbent filters are used, but such separation is difficult and the excitation light is not totally rejected.

Dichroic filters have a high level of rejection for the excitation light, of the order of 50 decibels (dB) to 90 dB, i.e. 1 part in 10⁻⁵ to 1 part in 10⁻⁹. When the intensity of the emitted fluorescence is low, i.e. when it is 10⁵ to 10⁹ times weaker than the excitation light, reflection of the excitation light by the support constitutes a significant background that hinders detecting the weak signals, and prevents a high signal/noise ratio being obtained.

Reflection at an air/glass interface is typically 4% for angles of incidence of upto about 20° from the normal. Beyond that, it increases or decreases as a function of angle and as a function of the polarization of the light. When the support is a transparent thin plate with parallel faces, the reflection of excitation light by the face of the plate opposite from the face carrying the chromophore elements is of comparable intensity (4% of 96%, i.e. 3.84%), and is likewise troublesome.

When using direct imaging over a relatively large area of the support, the two reflected intensities act together so reflection amounts to about 8%, which is far from being negligible.

When using supports that are highly reflective at the excitation wavelength, reflectivity is at a maximum and close to 100%.

Nevertheless, it is advantageous for the support to be reflective at the wavelength of the emitted fluorescence, since that makes it possible to multiply the intensity of the emitted fluorescence that can be picked up by about 2 (with geometrical optics) or about 4 (with wave optics).

### OBJECTS AND SUMMARY OF THE INVENTION

A particular object of the invention is to provide a solution to this problem which is simple, effective, and inexpensive, enabling the reflection of excitation light by the support to be cancelled or at least reduced, while conserving the advantage that results from reflecting the emitted fluorescence.

To this end, the invention provides a support for chromophore elements, the elements being for illumination by excitation light in order to emit fluorescence at a wavelength different from that of the excitation light, the support including at least one internal layer of material that reflects the fluorescence emitted by the chromophore elements, and at least one means for canceling or at least significantly reducing reflection of the excitation light, said means being selected from the group consisting of:
a layer of material that absorbs the excitation light, said layer having a thickness such that the product of said thickness multiplied by its absorption coefficient ae at the excitation wavelength is much greater than 1, or has a value that is known and controlled lying in the range 0.1 to 10 approximately;
at least one layer of transparent material constituting an antireflection layer at the excitation wavelength, formed on at least one face of the support and having a refractive index n′ close to square root of the refractive index of the support and a thickness equal to an odd multiple of λe/4n′ cos θ, where λe is the excitation wavelength and θ is the angle of the excitation rays in said antireflection layer; and
dielectric and/or metallic layers defining a microcavity, with the mode of the cavity being defined to cancel reflection of the excitation light.

In the support of the invention, reflection of the excitation light towards the means for collecting the fluorescence from the chromophore elements is greatly decreased or even cancelled, and the intensity of the fluorescence is increased, thus making it much easier to detect and measure said fluorescence.

According to another characteristic of the invention, the absorbent layer and at least one above-mentioned antireflection layer are formed on the face of the support opposite from its face carrying the chromophore elements.

When the support is transparent at the excitation wavelength, this makes it possible to cancel reflection at said wavelength at the face of the support opposite from the face carrying the chromophore elements.

According to another characteristic of the invention, an absorbent layer and at least one above-mentioned antireflection layer are formed on the face of the support for receiving the chromophore elements. Thus, when the support is made of a material that is transparent at the excitation wavelength, reflection of said wavelength by the face of the support carrying the chromophore elements is cancelled.

Under such circumstances, the absorbent layer is formed on the top face of the support, and the antireflection layer is formed on the absorbent layer.

In an embodiment of the invention, the internal layer of material reflecting the fluorescence emitted by the chromophore elements is situated at a distance d from the face of the support carrying the chromophore elements, where d is much greater than the quantity λf.n/2NA², λf being the wavelength of the emitted fluorescence, n being the refractive index of the support, and NA being the numerical aperture of the optical means for collecting the emitted fluorescence, and the above-mentioned antireflection layer is formed on the face of the support that is to receive the chromophore elements.

This very simple embodiment benefits from the advantages that result from reflecting the emitted fluorescence (doubling the intensity that can be picked up), while avoiding the drawbacks of the excitation light being reflected by the reflective layer integrated in the support.

Advantageously, an absorbent layer of the above-specified type can be formed in the support between the antireflection layer and the internal layer that reflects the emitted fluorescence.

According to another characteristic of the invention, the reflective internal layer may be made up of a plurality of dielectric layers and it is constituted so as to have substantially zero reflectivity at the excitation wavelength for the angle of incidence of the excitation light on the support.

To do this, the reflective internal layer may be formed by a stack of layers of optical thickness equal to one-fourth the wavelength of the excitation wave, and refractive indices that alternate between being high and low, with a central layer of thickness that is double or different. This stack of layers forms a symmetrical Fabry-Perot cavity, also known as a microcavity.

In this stack, the wavelength of the reflection minimum, the angle, and the polarization that are used are determined by the thickness of the cavity-forming layer.

In this embodiment, an absorbent layer of the above-specified type is advantageously formed in the support between the reflective internal layer and the face of the support opposite from its face that is to carry the chromophore elements.

In another embodiment of the invention, the internal layer of material that reflects the emitted fluorescence is situated at a distance from the face of the support carrying the chromophore elements that is less than the quantity λf.n/2NA², and an above-specified absorbent layer is formed between said reflective internal layer and the face of the support that is to carry the chromophore elements.

In this embodiment, the internal layer of reflective material may be a metallic or a dielectric layer, or it may be a plurality of dielectric layers.

In another embodiment of the invention, the support comprises two layers of material for reflecting the emitted fluorescence, these two layers forming an asymmetrical Fabry-Perot cavity and being situated at a distance from the face of the support that is to carry the chromophore elements that is less than the quantity λf.n/2NA², and the above-mentioned absorbent layer is situated between these two reflective layers and the face of the support opposite from its face that is to carry the chromophore elements.

In this embodiment, the chromophore elements may be carried by one of the layers of reflect material, outside the Fabry-Perot cavity.

In another embodiment of the invention, the support has a first layer of material that reflects the emitted fluorescence which is situated at a distance from the face of the support that is to carry the chromophore elements, where said distance is less than the quantity λf.n/2NA², a second layer of reflective material covering the face of the support that is to carry the chromophore elements and that is situated at a distance from the first reflective layer that is less than the quantity λf.n/2NA², and an above-specified absorbent layer situated between the first layer of reflective material and the face of the support opposite from the face that is to carry the chromophore elements.

In this embodiment, the chromophore elements are between two layers of reflective material and can be inserted between these two layers by known means, e.g. by passing through porous materials or by means of microchannels opening out into empty planar cavities formed by sacrificial etching of a stack of layers provided for this purpose.

The invention is equally applicable when the support is to carry chromophore elements of different types that emit fluorescence at different wavelengths when they are excited by appropriate different wavelengths.

The above-specified absorbent layer then has different absorption bands corresponding to the excitation wavelengths and may be formed for this purpose either out of a single suitable ingredient, or else out of a mixture of ingredients having different absorption bands. Similarly, the above-specified antireflection layer may be formed by a stack of layers presenting low reflection for the various excitation wavelengths. It is also possible to use a single antireflection layer having a refractive index close to the square root of the index of the material of the support, and thickness determined so as to minimize reflection at a wavelength lying between two excitation wavelengths that are relatively close to each other, the spectrum width of the reflection minimum typically being more than 100 nanometers (nm) in the visible spectrum, thus making it possible, for example, to determine a thickness for the layer corresponding to a reflection minimum centered on 580 nm when using excitation wavelengths of 532 nm and 633 nm.

In general, the invention makes it possible significantly to increase the signal-to-noise ratio and to minimize the background signal in light sensors for detecting and measuring the fluorescence emitted by chromophore elements in a biochip type device.

### BRIEF DESCRIPTION OF THE DRAWINGS

The invention will be better understood and other characteristics, details, and advantages thereof will appear more clearly on reading the following description made by way of example with reference to the accompanying drawings, in which:

FIGS. 1 to 3 are diagrammatic section views on a large scale of various embodiments of a support of the invention;

FIG. 4 is a graph showing how light reflection varies as a function of wavelength for the support of FIG. 3; and

FIGS. 5, 6, and 7 are diagrammatic section views showing other variant embodiments of the invention.

### MORE DETAILED DESCRIPTION

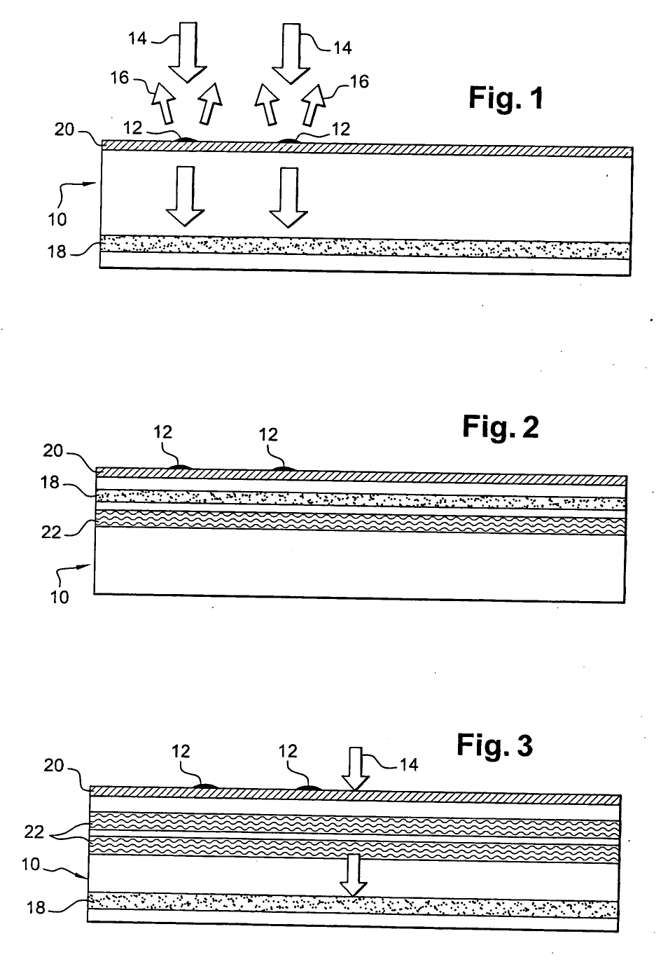

In FIG. 1, reference 10 is an overall reference for a support of the invention, which in this embodiment is constituted essentially by a plate of material having a refractive index n, with a top face for carrying chromophore elements 12, e.g. chemical or biological molecules as mentioned above, and which are secured in an array on the top face of the support 10.

These chromophore elements 12 are illuminated by excitation light 14, generally monochromatic light or narrow spectrum light, possibly polarized (laser light), and at an angle of incidence that is accurately defined and that is often substantially perpendicular to the surface of the support 10, and in response, these chromophore elements 12 emit fluorescence 16 at a wavelength that depends on the nature of the chromophore elements 12, and that is longer than the wavelength of the excitation light 14.

The intensity of the fluorescence emitted by the chromophore elements 12 is very weak compared with that of the excitation light 14.

In practice, it is necessary to illuminate a relatively large number of chromophore elements in order to obtain light signals 16 that can be used. It is therefore particularly advantageous to enhance recovery of the fluorescence 16 emitted by the chromophore elements 12 and to decrease the noise and the excitation signal in the signal picked up by the detection measurement means, which are generally placed above the chromophore elements 12 and of optical axis extending perpendicularly to the top surface of the support 10.

For this purpose, the present invention proposes reducing, and insofar as possible canceling, reflection of the excitation light 14 by the support 10 so as to prevent any such reflected light adding to the emitted fluorescence 16 in the light signal picked up by the detection and measurement means, the percentage of the intensity of the excitation light reflected by the support 10 at angles of incidence that are substantially normal being about 4% at each interface when the support 10 is made of glass having a reflective index of 1.5, or about 25% at each interface when the support 10 is made of silicon having a refractive index of 3.5 (where the index of the medium overlying the support is equal to 1).

The invention proposes adding at least one of the following means to the support 10:
an absorbent layer 18 made of a material having a refractive index that is close to that of the support 10, the thickness d of the absorbent layer being determined so that the product of multiplying said thickness d by its absorption coefficient αe at the wavelength of the excitation light is much greater than 1, or in a variant has a value that is known and controlled and that lies in the range 0.1 to 10, approximately;
one or more transparent layers 20 constituting antireflection layers for the excitation wavelength, i.e. layers 20 made of a material having a refractive index n′ close to the square root of the refractive index of the support 10, and of thickness equal to λe/4n′ cos θ or an odd multiple of said thickness, θ being the angle relative to the normal of the excitation rays in the or each layer 20.

When the angle of incidence is greater than about 55°, and the excitation light has p polarization (electric field in the plane of incidence), it is possible to cancel reflection of the excitation light by the support by adjusting the angle of incidence i to the Brewster angle, as given by the relationship i=arctan(n), where n is the refractive index of the material of the support. Under such circumstances, the absorbent layer 18 is inside the support.

As shown in FIG. 1, one or more antireflection layers 20 can be formed on the top surface of the support 10, and an absorbent layer 18 can be formed on the bottom face of the support 10, or in the vicinity thereof, the chromophore elements 12 then being deposited on the antireflection layer(s) 20.

When the support 10 is made of transparent material, it is also possible to form one or more antireflection layers and an absorbent layer on its bottom face in order to cancel reflection of the excitation light 14 by the bottom face of the support.

It is also possible to treat the top surface of the support 10 in the same manner, i.e. to cover it in an absorbent layer 18, itself covered in one or more antireflection layers 20.

Under such circumstances, the excitation light 14 is absorbed without passing through the support 10, thereby eliminating any parasitic emission from the support 10 at the wavelength of the fluorescence 16 emitted by the chromophore elements 12.

When the support 10 is made of glass, the antireflection layer 20 can be made of magnesium fluoride MgF₂ having a refractive index close to 1.38. If the wavelength of the excitation light is 532 nm, then the thickness of the layer 20 is about 100 nm.

The absorbent layer 18 may be of organic molecules, possibly embedded in a sol-gel type matrix or in a polymer matrix, or it may be made of inorganic pigments embedded in the said matrices, or indeed it may be made of quantum boxes of the CdS or CdSe type, for example, which are dispersed in a matrix and treated to cancel their own luminescence.

As shown in FIG. 2, the support 10 preferably also includes a mirror 22 formed by an internal layer of material that reflects light at the wavelength of the fluorescence emitted by the chromophore elements 12, this mirror 22 being situated at a distance from the chromophore elements 12 that is much greater than the quantity λf.n/2NA², λf being the wavelength of the emitted fluorescence 16, n being the refractive index of the support 10, and NA being the numerical aperture of the optical means for detecting and measuring the emitted fluorescence.

The decrease in reflection of the excitation light 14 is obtained by means of an antireflection layer 20 formed on the top face of the support 10 and by means of an absorbent layer 18 interposed in the support 10 between the antireflection layer 20 and the mirror 22.

The distance between the mirror 22 and the top face of the support 10 is relatively large, in particular greater than 5 micrometers (μm), thus enabling the absorbent layer 18 to be installed between the mirror 22 and the antireflection layer 20 without difficulty.

The reflecting layer 22 constituting the mirror maybe made up of a plurality of dielectric layers presenting zero reflection for the wavelength of the excitation light at the angle of incidence used, which is generally small and less than 10°.

As shown diagrammatically in FIG. 3, it is possible to form a symmetrical Fabry-Perot microcavity or cavity between the two mirrors 22 each made up of stacks of dielectric layers having the same reflectivity.

To do this, it is possible, for example, to make a stack of layers of materials alternately presenting a high refractive index H and a low refractive index L, such as TiO₂ and SiO₂, respectively, each layer having an optical thickness equal to λe/4, the stack being, for example, HLHLHLHL-X-LHLHLHLH, where L and H designate layers of low and high index respectively and X designates a layer of type H, e.g. forming a cavity of thickness making it possible to adjust the wavelength of the cavity mode(s) for which reflection is zero.

Naturally, reflection of the excitation light on the bottom face of the support 10 can be limited by depositing an antireflection layer 20 and an absorbent layer 18.

In the embodiment of FIG. 3, an absorbent layer 18 is in the vicinity of the bottom face of the support 10, while an antireflection layer 20 is formed on the top face of the support and carries the chromophore elements 12.

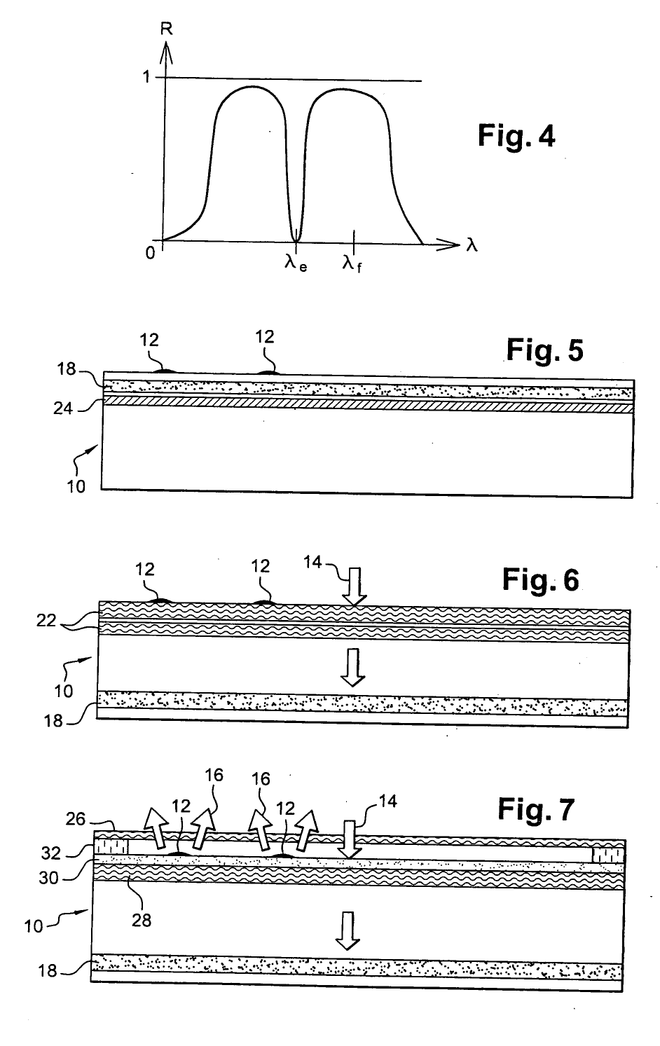

Under such circumstances, and as shown diagrammatically in FIG. 4, the reflectance of the support 10 is zero at the excitation wavelength λe and is very high, preferably close to 100% at the wavelength λf of the fluorescence emitted by the chromophore elements.

In the embodiment of FIG. 5, the support 10 is a plate of material having a refractive index n which includes a reflective layer 24 of high reflectance which is metallic or formed by a stack of dielectric layers and which is situated at a distance d from the top face of the support carrying the chromophore elements 12, where d is less than the quantity λf.n/2NA², where λf is the wavelength of the fluorescence emitted by the chromophore elements 12, and where NA is the numerical aperture of the optical means for detecting and measuring said fluorescence.

This makes it possible to generate an interference effect that improves collection of the emitted fluorescence in application of the laws of wave optics. From the above-specified earlier applications in the names of the same inventors, it is known that it is thus possible to generate dual resonance of the excitation light and of the emitted fluorescence by causing the anti-nodes of the electric fields of those two wavelengths to coincide on the chromophore elements 12 carried by the top face of the support 10. It is also possible to generate resonance for the emitted fluorescence only, with an arbitrary interference state for the excitation light on the chromophore elements.

In this embodiment, reflection of the excitation light is cancelled or decreased by forming an absorbent layer 18 of determined thickness between the reflective layer 24 and the chromophore elements 12, this thickness being less than or greater than the thickness between the reflective layer 24 and the chromophore elements 12.

The layer 18 serves to absorb as much as necessary of the excitation wavelength without absorbing the wavelength of the emitted fluorescence.

It is possible to determine a value for the product αe.d, where ae is the absorption coefficient of the layer 18 at λe, and d is the thickness of said layer, and a distance D between the reflective layer 24 and the face of the support that is to carry the chromophore elements, that are such that the overall reflectivity of the support is zero at λe. If r1 is the amplitude reflectivity at λe at the air-support interface for a given angle of incidence and polarization, and if r2 is the amplitude reflectivity at λe of the layer 24, it is possible to cancel the first reflection with the second if, in amplitude terms:
r2 exp(−αe.d)=r1
i.e.:
αe.d=Ln(r2/r1)
and if 2n.D cos θ is an odd multiple of λe/2, θ being the angle of incidence of the excitation light on the layer 24, so that the rays generated by the two reflections are of substantially the same amplitude and in phase opposition.

This condition concerning phase is the same as that which ensures reinforcement of the excitation on the chromophore elements 12, as stated in the above-mentioned prior applications in the names of the inventors. It is thus possible to use a layer 18 that is less absorbent and thus thinner, and to reduce the constraint on the reflectivity of the layer 24 at λe, since it is possible to use the layer 18 to cancel the combined effect of the excitation light being reflected both on the top face of the support 10 and on the layer 24.

In a variant, and as shown in FIG. 6, it is possible to replace the metallic reflective layer 24 by an asymmetrical Fabry-Perot cavity formed by two different reflective layers 22, one forming the top face of the support 10 and carrying the chromophore elements 12, and the other being located inside the support 10 and situated at a distance from the chromophore elements 12 that is less than the above-specified quantity λf.n/2NA².

An absorbent layer 18 is then formed on the bottom face of the support 10 or in the vicinity of said bottom face, possibly in combination with an above-specified antireflection layer 20.

It is thus possible to form in the support a microcavity having metallic mirrors serving to cancel reflection of the excitation light (the mode of the cavity corresponding to the excitation wavelength at the angle of incidence used).

Solutions based on microcavities (having dielectric or metallic mirrors) make it possible to obtain reflectivity contrast between the excitation and emission wavelengths that is much greater than a solution based on an antireflection layer made on a reflective support, thereby decreasing noise associated with wavelength light.

In a variant, it is possible to use a Bragg mirror formed by periodic stacks of layers of high-index and low-index materials, presenting a relatively narrow band so as to have strong reflectivity at the wavelength of the emitted fluorescence and weak reflectivity outside said band, by adding to the Bragg mirror an antireflection layer or an absorbent layer of the above-specified type, but of very small thickness so as to remain within the domain of wave optics.

Two preferred embodiments of the invention are then as follows:
the Bragg mirror is formed so as to present the exact amplitude and phase for reflectivity at λe such that the combination of reflection by the Bragg mirror with reflection at the top face of the support 10 cancels the overall reflection at λe by the support; or
the Bragg mirror is not precisely adjusted in terms of reflectivity and above all amplitude, and is of broad band, so it is the absorbent layer 18 interposed between said mirror and the top face of the support 10 that enables overall reflection of the support at λe to be canceled by suitably selecting the product αe.d, as stated above.

It is possible to use known optical synthesis methods such as the “flip-flop” method in order to form the stack of layers constituting the Bragg mirrors.

Very generally, it is possible to act on the angle of incidence and the polarization of the excitation light in order to achieve cancellation of overall reflection by the support, while simplifying as much as possible the synthesis of the stacked layers, so as to comply with other constraints contributing to obtaining a good fluorescence signal. In another aspect, it is possible to associate the support of the invention with lighting means delivering excitation light at an angle of incidence and at polarization that are defined so as to reduce the parasitic reflection from the support.

Under wave optics conditions, implementations of the invention using reflective multilayers (microcavity, Bragg mirrors, . . . ) also make it possible to ensure that the chromophore elements are located in the vicinity of an anti-node in the emission field, as has already been described in the above-specified international application in the names of the same inventors.

In the embodiment of FIG. 7, the support 10 comprises a plate of material having a refractive index n and two mirrors 26 and 28 that are spaced apart, with the chromophore elements 12 being located between them.

More precisely, the chromophore elements 12 are carried by a layer 30 of transparent material covering the bottom mirror 28, and the top mirror 26 covers the layer 30, while being spaced apart therefrom by a spacer layer 32, e.g. etched to as form cavities in which the chromophore elements 12 are deposited.

The mirrors 26 and 28 operate under wave optics conditions, i.e. the mirror 28 is spaced apart from the chromophore elements 12 by a distance that is less than the quantity λf.n/2NA², and the distance between the two mirrors 26 and 28 is less than the quantity λf.n/NA².

The characteristics of the mirrors 26 and 28 are determined so that the excitation wavelength is transmitted by the bottom mirror 28 and the wavelength of the emitted fluorescence is reflected by the mirror 28 and passes through the top mirror 26 in order to be picked up by the detection and measurement means.

An absorbent layer 18 of the above-specified type is formed on or in the vicinity of the bottom face of the support 10, and is optionally associated with an above-specified antireflection layer as for the above-described embodiments.

What is claimed is:

1. A chromophore element support, said elements being for illumination by excitation light in order to emit fluorescence at a wavelength different from that of the excitation light, the support including at least one internal layer of reflective material reflecting the fluorescence emitted by the chromophore elements, and at least one means for canceling or at least significantly reducing reflection of the excitation light, said means being selected from the group consisting of:
a layer of absorbent material that absorbs the excitation light;
at least one layer of transparent material constituting an antireflection layer at the excitation wavelength, said layer being formed on at least one face of the support and having a refractive index n′ close to the square root of the refractive index of the support, and a thickness equal to an odd multiple of λe/4n′ cos θ, θ being the angle of incidence of the excitation light rays in said antireflection layer; and
dielectric and/or metallic layers defining a microcavity of cavity mode that is defined to cancel reflection of the excitation light.

2. A support according to claim 1, wherein the absorbent layer is of a thickness such that the product of said thickness multiplied by its absorption coefficient ae at the excitation wavelength is much greater than 1, or has a value that is known and controlled lying in the range 0.1 to 10 approximately.

3. A support according to claim 1, wherein the absorbent layer and at least one above-mentioned antireflection layer are formed on the face of the support opposite from its face carrying the chromophore elements.

4. A support according to claim 1, wherein an absorbent layer and at least one above-mentioned antireflection layer are formed on the face of the support for receiving the chromophore elements.

5. A support according to claim 4, wherein the antireflection layer is formed on the absorbent layer.

6. A support according to claim 1, for use with optical means for collecting the emitted fluorescence having a numerical aperture NA, wherein the internal layer of material reflecting the fluorescence emitted by the chromophore elements is situated at a distance d from the face of the support for carrying the chromophore elements that is much greater than the quantity λf.n/2NA², and at least one above-mentioned antireflection layer is formed on the face of the support for receiving the chromophore elements.

7. A support according to claim 6, also including an above-mentioned absorbent layer formed between the antireflection layer and the internal reflecting layer.

8. A support according to claim 6, wherein the internal reflecting layer comprises a plurality of dielectric layers and presents substantially zero reflectivity at the excitation wavelength for the angle of incidence of the excitation light on the support.

9. A support according to claim 8, wherein said internal reflecting layer comprises a stack of layers each of thickness equal to λe/4 and of refractive indices that are alternately and high and low, defining a symmetrical Fabry-Perot cavity.

10. A support according to claim 9, wherein the thickness of the cavity is determined so as to obtain zero reflectivity at the excitation wavelength.

11. A support according to claim 8, including an above-mentioned absorbent layer between the internal reflecting layer and the face of the support opposite from that for carrying the chromophore elements.

12. A support according to claim 1, for use with optical means for collecting the emitted fluorescence and having numerical aperture NA, wherein the internal layer of material that reflects the emitted fluorescence is situated at a distance from the face for carrying the chromophore elements that is less than the quantity λf.n/2NA².

13. A support according to claim 12, wherein an above-mentioned absorbent layer is formed between the internal reflective layer and the face of the support for carrying the chromophore elements.

14. A support according to claim 12, wherein the internal layer of reflecting material is a metallic layer or a stack of dielectric layers.

15. A support according to claim 13, wherein the thickness of the absorbent layer and its coefficient of absorption at the excitation wavelength, and also the distance between the reflective layer and the face of the support for carrying the chromophore elements are determined so as to cancel the overall reflection of excitation light by the support, with the product of the thickness multiplied by the absorption coefficient of the absorbent layer being determined so that the amplitudes of the excitation light reflected firstly by said face of the support, and secondly by the reflective layer are substantially equal, and the distance of said face from the reflective layer being determined so that their phases are in phase opposition on said face of the support.

16. A support according to claim 15, wherein the distance D between the reflective layer and said face of the support is such that the quantity 2n.D cos θ is an odd multiple of half the wavelength of the excitation wave.

17. A support according to claim 12, wherein the internal reflective layer is formed by a Bragg mirror reflecting the excitation light with amplitude and phase such that on being combined with the excitation light reflected by the face of the support for carrying the chromophore elements, the overall reflection of excitation light by the support is substantially zero.

18. A support according to claim 1, for use with optical means for collecting the emitted fluorescence and having a numerical aperture NA, the support including two layers of reflective material for reflecting the emitted fluorescence, said two layers forming an asymmetrical Fabry-Perot cavity and being situated at a distance from the face of the support for carrying the chromophore elements that is less than λf.n/2NA², and an above-mentioned absorbent layer situated between said reflective layers and the face of the support opposite from its face for carrying the chromophore elements.

19. A support according to claim 1, for use with optical means for collecting the emitted fluorescence and having a numerical aperture NA, the support including two layers of reflective material for reflecting the emitted fluorescence, one of these layers being situated inside the support at a distance from the face for carrying the chromophore elements that is less than the quantity λf.n/2NA², the other of these layers covering face of the support for carrying the chromophore elements and being situated at a distance from the first reflective layer that is less than the quantity λf.n/NA², and an above-mentioned absorbent layer formed in the support between the first layer of reflective material and the face of the support opposite from the face for carrying the chromophore elements.

20. A support according to claim 1, wherein the above-mentioned absorbent layer is made of organic molecules, optionally embedded in a sol-gel or polymer type matrix, or of inorganic pigments embedded in a sol-gel type matrix, or of quantum boxes e.g. of CdS or CdSe type dispersed in a matrix and not presenting their own luminance.

21. A support according to claim 1, for illumination by excitation light of p polarization at an angle of incident that is the Brewster angle corresponding to the material of the support, and including an above-mentioned absorbent layer situated inside the support.

22. A support according to claim 1, for carrying chromophore elements of at least two different types, emitting fluorescence at different wavelengths, wherein said antireflection layer presents low reflectivity for at least two of the above-mentioned excitation wavelengths.

23. A support according to claim 22, wherein said antireflection layer comprises a stack of layers presenting low reflectivity at a plurality of excitation wavelengths.

24. A support according to claim 22, wherein said absorbent layer comprises ingredients that absorb at different wavelengths.
